(19) United States
(12) Patent Application Publication
(10) Pub. No.: US 2014/0185053 A1
(43) Pub. Date: Jul. 3, 2014

(54) OPTICAL INTERFEROMETRIC APPARATUS

(71) Applicant: NATIONAL CENTRAL UNIVERSITY, Jhongli City (TW)

(72) Inventors: Chu-En LIN, Kaohsiung City (TW); Chii-Chang CHEN, Pingzhen City (TW)

(73) Assignee: NATIONAL CENTRAL UNIVERSITY, Jhongli City (TW)

(21) Appl. No.: 14/039,714

(22) Filed: Sep. 27, 2013

(30) Foreign Application Priority Data
Dec. 28, 2012 (TW) 101151079

(51) Int. Cl. G01C 19/72

(52) U.S. Cl. CPC G01C 19/72
USPC 356/460

(57) ABSTRACT

An optical interferometric apparatus comprises a light source emitting a coherent light, a polarizing beam-splitting element splitting the light into a first light and second light which travel along an optical fiber element and then are combined. Then, a beam-splitting element split the combined light into a third light and a fourth light, and a first phase-modulation element and a second phase-modulation element respectively are disposed on the optical paths of the third and fourth lights. A first polarization element and a second polarization element respectively superpose the P wave and S wave of the third and fourth lights, and a first detection element and a second detection element respectively detect the third and fourth lights to respectively generate a first polarized signal and a second polarized signal. A demodulation computing element is used to calculate and determine phase information according to the first and second polarized signals.

### CROSS REFERENCE TO RELATED APPLICATIONS

This Non-provisional application claims priority under 35 U.S.C. §119(a) on Patent Application No(s). 101151079 filed in Taiwan, Republic of China on Dec. 28, 2012, the entire contents of which are hereby incorporated by reference.

### BACKGROUND OF THE INVENTION

1. Field of Invention

The invention relates to an optical interferometric apparatus.

2. Related Art

A gyroscope can sense its angular velocity relative to an inertial system, and has been widely applied to the military field and economic field, such as automobile industry, engineering measurement and precision positioning control of robot. Moreover, the gyroscope also can make aircraft serve a stable and smooth flight. With the enormous progress of micro-electro-optical-mechanical processes (MEOMS) and optical fiber technologies, a conventional mechanical gyroscope has been replaced by a gyroscope with electromagnetic or optical schemes. Since the optical interferometric gyroscopes are capable of rapid response, high sensitivity for navigation, they played an important role in science and industry recently.

It is known that the Sagnac effect is a basic principle of optical gyroscope. In general, an interferometer with a configuration of ring is also named as Sagnac interferometer. In this configuration, an irreversible phase shift which is named by Sagnac phase is caused by the clockwise and counterclockwise light path in Sagnac interferometer. Thus, we can obtain the angular velocity of an object from Sagnac phase.

Optical gyroscope has many types. In 1980s, scientists combined heterodyne technique and fiber-optics gyroscope to develop many kinds of heterodyne gyroscopes. However, the conventional heterodyne Sagnac interferometer uses a non-common path configuration such as Mach-Zehnder interferometer or Michelson interferometer, where the optical paths of the reference light and signal light are different. Accordingly, the non-common path Sagnac interferometer will be very sensitive to the external disturbance such as temperature, vibration, etc. Hence, when such non-common path heterodyne interferometer (such as a gyroscope) is installed on a moving body, the external disturbance becomes a leading noise source.

Therefore, it is an important subject to provide an optical interferometric apparatus which has a common-path configuration for suppressing the external disturbance so as to achieve the more precise measurement. In addition, this kind of interferometric apparatus not only can serve a full-dynamic range measurement but also eliminate the optical rotation in single-mode-fiber.

### SUMMARY OF THE INVENTION

In view of the foregoing subject, an objective of the invention is to provide a full-dynamic range optical interferometric apparatus that uses a common-path configuration for suppressing the environmental disturbance so as to achieve the more precise measurement.

To achieve the above objective, an optical interferometric apparatus related to this invention comprises a light source, a polarizing beam-splitting element, an optical fiber element, a beam-splitting element, a first phase-modulation element and a second phase-modulation element, a first polarization element and a second polarization element, a first detection element and a second detection element, a first filter element and second filter element, and a demodulation computing element. The light source can emit a coherent light, such as a coherent light with two polarization states which are perpendicular to each other and have different frequencies. The polarizing beam-splitting element splits the light into a first light and a second light which have different polarization states. The first and second lights are transmitted and reflected into the optical fiber. Then, these two lights pass along the optical fiber in a first optical path and a second optical path. Again, the first and second lights are combined to become a combined light after passing through the same polarizing beam-splitting element. The beam-splitting element splits the combined light into a third light and a fourth light. The first and second phase-modulation elements are respectively disposed on the optical paths of the third and fourth lights, and respectively retard the phases of the third and fourth lights. The first and second polarization elements are respectively disposed on the optical paths of the third and fourth lights, two polarization states of each of the third and fourth lights are projected on the transmission axes of the first and second polarization elements. Then, a first polarized light and a second polarized light are generated. The first and second detection elements respectively detect the first polarized light passing through the first polarization element and the second polarized light passing through the second polarization element. When the first polarized light and the second polarized light are received by the first detection element and the second detection element respectively, the first polarized signal and second polarized signal are generated. The demodulation computing element processes and obtain a phase information with Sagnac-phase information according to the first and second polarized signals.

In one embodiment, the light source includes an equi-amplitude two-frequency laser source (TFLS).

In one embodiment, the light passes through the polarizing beam-spitting element to generate the first light and second light respectively.

In one embodiment, the first and second lights are respectively a primary wave (P wave) and a secondary wave (S wave), or respectively a secondary wave and a primary wave.

In one embodiment, the optical fiber element includes a single-mode optical fiber or a polarization-maintaining optical fiber.

In one embodiment, the optical fiber element includes at least a turn of optical fiber.

In one embodiment, the first and second optical paths are the combination of a clockwise direction and a counter clockwise direction.

In one embodiment, the first and second polarized lights have the same optical path-length.

In one embodiment, the transmission directions of the first and second optical paths in the optical fiber element are opposite to each other.

In one embodiment, at different times, the first phase-modulation element and the second phase-modulation element retard different phase to the third light and the fourth light, respectively.

In one embodiment, the included angle between the two polarization states of the third light and the transmission axis of the first polarization element is 45°, and the included angle between the two polarization states of the fourth light and the transmission axis of the second polarization element is also 45°.

In one embodiment, the included angle between the x axis and each of the transmission axes of the first and second polarization elements is 45°.

In one embodiment, the optical interferometric apparatus further comprises a first polarization converting element and a second polarization converting element. The first polarization converting element is disposed on the optical path of the third light and rotates the two polarization states (P wave and S wave) of third light at a first angle. The second polarization converting element is disposed on the optical path of the fourth light and rotates the two polarization states (P wave and S wave) of the fourth light at a second angle.

In one embodiment, the first angle and the second angle both are 45°.

In one embodiment, the included angle between the x axis and each of the transmission axes of the first and second polarization elements is zero.

In one embodiment, at least two of the polarizing beam-splitting element, the beam-splitting element, the first and second phase-modulation elements, the first and second polarization converting elements and the first and second polarization elements are made in an integrated optical circuit.

In one embodiment, the first phase-modulation light having the first angle is incident on the first polarization element, and the second phase-modulation light having the second angle is incident on the second polarization element.

In one embodiment, the optical interferometric apparatus further comprises a first filter element and a second filter element. The first filter element is electrically connected to the first detection element which receives the first polarized signal to generate a third polarized signal. The second filter element is electrically connected to the second detection element which receives the second polarized signal to generate a fourth polarized signal.

In one embodiment, the demodulation computing element receives the third and fourth polarized signals, and it determines and calculates a Sagnac phase according to the third and fourth polarized signals.

In one embodiment, the demodulation computing element obtains an angular velocity according to the phase information.

In one embodiment, the optical interferometric apparatus is a heterodyne interferometric gyroscope or a heterodyne interferometer.

As mentioned above, in the optical interferometric apparatus according to the invention, the light emitted by the light source is split by the polarizing beam-splitting element which combined the split lights after passing through the optical fiber. Then, the combined light split again by the beam-splitting element after passing through the optical fiber element. The lights which are split by the beam-splitting element pass through the first and second phase-modulation elements and the first and second polarization elements respectively. Then, the lights are received by the first and second detection elements correspondingly. Thereby, the optical interferometric apparatus has a common-path configuration so as to suppress the environmental disturbance and achieve more precise measurement. Moreover, this kind of interferometric apparatus not only can serve a full-dynamic range measurement but also eliminate the optical rotation in single-mode-fiber. Besides, the first and second filter elements can filter out the direct current (DC) component of the third and fourth signals. The demodulation computing element can demodulate the two signals which are modulated by the first and second phase-modulation elements at different times and calculated the phase information with Sagnac phase information. Therefore, the optical interferometric apparatus can be a heterodyne interferometer. In an embodiment of this invention wherein the optical interferometric apparatus functions as a heterodyne interferometric gyroscope. According to calculating and determining the measured angular velocity, the Sagnac phase can be obtained by the phase information.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic block diagram of an optical interferometric apparatus according to a preferred embodiment of the invention; and

FIG. 2 is a schematic block diagram of an optical interferometric apparatus according another embodiment of the invention.

### DETAILED DESCRIPTION OF THE INVENTION

The present invention will be apparent from the following detailed description, which proceeds with reference to the accompanying drawings, wherein the same references relate to the same elements.

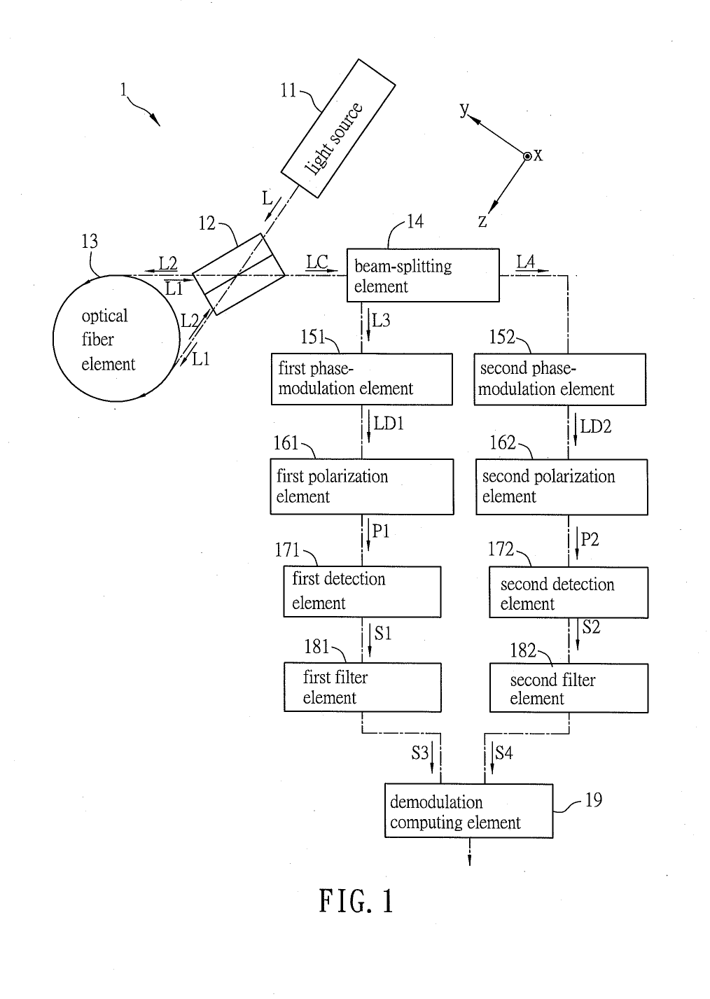

FIG. 1 is a schematic block diagram of an optical interferometric apparatus 1 according to a preferred embodiment of the invention.

In FIG. 1, the optical interferometric apparatus 1 includes a light source 11, a polarizing beam-splitting element 12, an optical fiber element 13, a beam-splitting element 14, a first phase-modulation element 151, a second phase-modulation element 152, a first polarization element 161, a second polarization element 162, a first detection element 171, a second detection element 172, a first filter element 181, a second filter element 182 and a demodulation computing element 19.

The light source 11 can emit a coherent light L. Herein for example, the light source 11 is an equi-amplitude two-frequency laser source (TFLS) which can emit a two-frequency equi-amplitude lights.

The incident light L which is emitted by the light source 11 is split by the polarizing beam-splitting element 12. Then, the incident light L is divided into a first light L1 and a second light L2. Herein, the polarizing beam-splitting element 12 can be a polarizing beam splitter (PBS), by which a specific polarized light can be reflected or transmitted for achieving the polarized light split or combination. The first and second lights L1 and L2 with orthogonal polarization states, which are split by the polarizing beam-splitting element 12 can be a combination of a primary wave (P wave) that is parallel to the x axis and a secondary wave (S wave) that is perpendicular to the x axis. In other words, the first light L1 can be the primary wave while the second light L2 is the secondary wave, and vice versa. In this embodiment, the first light L1 which passes through the polarizing beam-splitting element 12 is a primary wave, and the second light L2 which is reflected by the polarizing beam-splitting element 12 is the secondary wave.

After split by the polarizing beam-splitting element 12, the first light L1 and the second light L2 enter into the optical fiber element 13 from different ends, and then pass through the optical fiber element 13 in a first optical path and a second optical path, respectively. The optical fiber element 13 has at least a turn of optical fiber which can be a single-mode fiber or a polarization maintaining fiber, but this invention is not limited thereto. The first and second optical paths are the combination of a clockwise direction and a counter-clockwise direction, and are opposite to each other in the optical fiber element 13. In this embodiment, the first light L1 pass through the first optical path, i.e. the clockwise direction of the optical fiber element 13, while the second light L2 pass through the second path, i.e. the counterclockwise direction of the optical fiber element 13, and vice versa. Accordingly, it can be seen from FIG. 1 that the first path of the first light L1 and the second path of the second light L2 have the same light-pass length although they pass through different directions in optical fiber.

In this heterodyne gyroscope, the first light L1 and the second light L2 which travel along the optical fiber element 13 are combined by the same polarizing beam-splitting element 12 again after outputting from the optical fiber element 13. Also, the first light (P wave) transmit the polarizing beam-splitting element 12 and the second light (S wave) is reflected by the polarizing beam-splitting element 12. Accordingly, the first light L1 and the second light L2 are combined as a combined light LC (including P wave and S wave) by the polarizing beam-splitting element 12. After passing through the beam-splitting element 14, the combined light LC is divided into a third light L3 and a fourth light L4. Herein, the beam-splitting element 14 is a beam splitter (BS) for example. The third light L3 and the fourth light L4 each have P wave and S wave both. Moreover, these two lights have Sagnac phase information which arises by the previous clockwise and counter clockwise light pass in optical fiber element 13.

The first phase-modulation element 151 is disposed on the optical path of the third light L3, retarding a phase to the third light L3 (to both of the P wave and S wave) for generating a first phase-modulation light LD1. The second phase-modulation element 152 is disposed on the optical path of the fourth light L4, also retarding a phase to the fourth light L4 (to both of the P wave and S wave) for generating a second phase-modulation light LD2. Herein, the first and second-phase modulation elements 151 and 152 are each an electro-optic modulator (EOM) for example. At different times, the first phase-modulation element 151 and the second phase-modulation element 152 can retard different phase to the third light L3 and the fourth light L4, respectively.

The first polarization element 161 and the second polarization element 162 are respectively disposed on the optical paths of the third and fourth lights L3 and L4. The P wave and S wave of the third light L3 (the first phase-modulation light LD1 correspondingly) are projected on the transmission axis of the first polarization element 161 for generating a first polarized light P1. Similarly, the P wave and S wave of the fourth light L4 (the second phase-modulation light LD2 correspondingly) are projected on the transmission axis of the second polarization element 162 for generating a second polarized light P2. Herein, the first and second polarized lights P1 and P2 have become interference lights. According to the sequence of the optical path, the first polarization element 161 is disposed after the first phase-modulation element 151, and the second polarization element 162 is disposed after the second phase-modulation element 152. The first and second polarization elements 161 and 162 each are a polarizer for example. The P wave and S wave of the third light L3 (first phase-modulation light LD1 correspondingly) each project on the transmission axis of the first polarization element 161 at an included angle of 45°, and the P wave and S wave of the fourth light L4 (second phase-modulation light LD2 correspondingly) each project on the transmission axis of the second polarization element 162 at an included angle of 45°

The first detection element 171 and the second detection element 172 are respectively disposed on the optical paths of the third and fourth lights L3 and L4, and respectively detect the first polarized light P1 passing through the first polarization element 161 and the second polarized light P2 passing through the second polarization element 162 respectively. As a result of the first polarized light P1 and the second polarized light P2 are received by the first detection element 171 and the second detection element 172, a first polarized signal S1 and a second polarized S2 are generated respectively. Herein, the first and second detection elements 171 and 172 are photo detectors for example. The first and second polarized lights P1 and P2 each are heterodyne light. And besides, the two optical paths each are common-path. Therefore, the optical interferometric apparatus 1 has the ability of suppressing the external disturbance.

The first filter element 181 is electrically connected to the first detection element 171, and filters the first polarized signal S1 to generate a third polarized signal S3. The second filter element 182 is electrically connected to the second detection element 172, and filters the second polarized signal S2 to generate a fourth polarized signal S4. Herein, the first and second filter elements 181 and 182 are band-pass filters (BPF) for example, which can filter out the direct current (DC) component of the first and second polarized signals S1 and S2. Thus, only the alternating current (AC) component of the first and second polarized signals S1 and S2 remains. To be noted, after the effect of the first and second polarization elements 161, 162, the first and second polarized lights P1 and P2, the first and second polarized signals S1 and S2, and the third and fourth polarized signals S3 and S4 all obtain the heterodyne information.

According to the first and second phase-modulation elements 151 and 152, they modulate the third and fourth light L3 and L4 at different times respectively. Thus, the third and fourth polarized signals S3 and S4 are modulated signals. The demodulation computing element 19 receives and demodulates the third and fourth polarized signals S3 and S4 and then calculate and determine the phase information with the Sagnac phase information to obtain an angular velocity. Thus, the optical interferometric apparatus 1 can be a heterodyne interferometer. In this embodiment, the demodulation computing element 19 can include a demodulator and a calculator. It can demodulate the third and fourth polarized signals S3 and S4 and can execute calculation and determination process. The signal at beat frequency with phase information can be taken out when the third and fourth polarized signals S3 and S4 are received by the demodulation computing element 19. Thereby, the demodulation computing element 19 can demodulated the third and fourth polarized signals S3 and S4 including heterodyne information. Besides, a Sagnac phase can be obtained according to the phase information with AC component (by the equations described later). Moreover, the demodulated signals have forms of sine and cosine functions. According to the linear relationship between Sagnac phase and the angular velocity, the angular velocity can be calculated once the Sagnac phase is obtained. In other words, when the optical interferometric apparatus 1 is used to obtain an angular velocity, it functions as a heterodyne interferometric gyroscope.

As mentioned above, since the optical interferometric apparatus 1 uses a common-path configuration, it can suppress the external disturbance to achieve more precise measurement. Besides, the optical interferometric apparatus 1 not only has the advantage of full-dynamic range measurement but also eliminate the optical rotation which caused by single-mode-fiber.

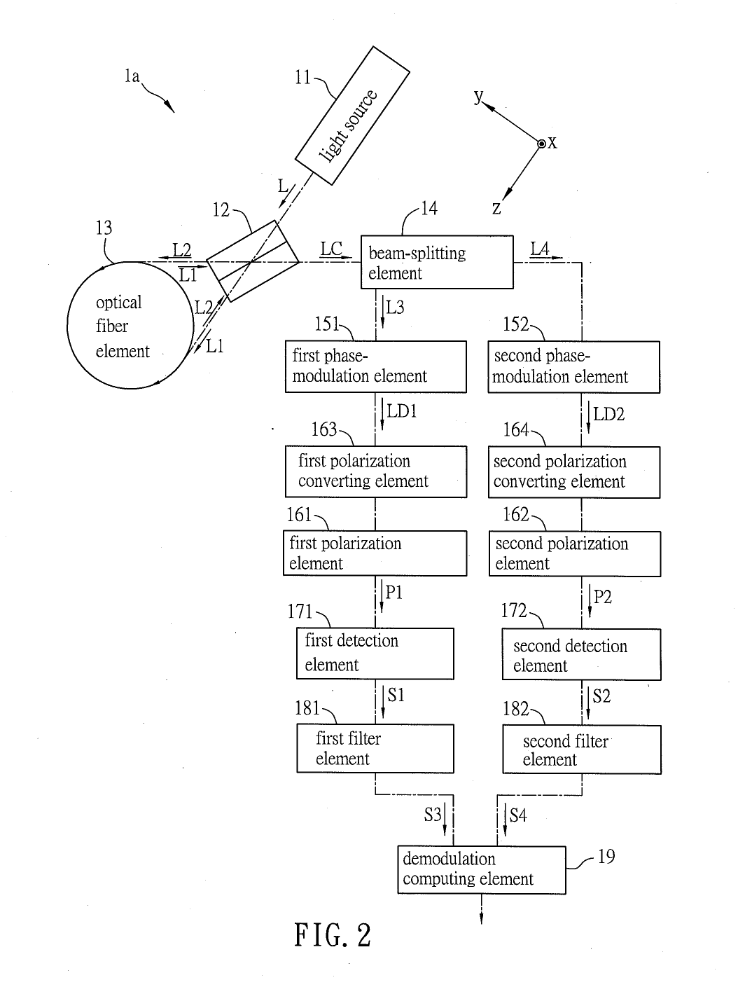

FIG. 2 is a schematic block diagram of an optical interferometric apparatus la according another embodiment of the invention.

Different from the optical interferometric apparatus 1, the optical interferometric apparatus 1a further includes a first polarization converting element 163 and a second polarization converting element 164.

The first polarization converting element 163 is disposed on the optical path of the third light L3. Herein, the first phase-modulation light LD1 passes through the first polarization converting element 163 and then reaches the first polarization element 161. The first polarization converting element 163 can make the two polarization states (P wave and S wave) of the third light L3 (or the first phase-modulation light LD 1) each differ from the transmission axis of the first polarization element 161 by a first angle (i.e. the P wave and S wave of the third light L3 each differ from the transmission axis by the first angle). The second polarization converting element 164 is disposed on the optical path of the fourth light L4, and can make the two polarization states (P wave and S wave) of the second phase-modulation light LD2 each differ from the transmission axis of the second polarization element 162 by a second angle (i.e. the P wave and S wave of the fourth light L4 each differ from the transmission axis by the second angle). In this embodiment, the x axis and each of the transmission axes of the first and second polarization elements 161 and 162 have an included angle of 0°, and the transmission axes are perpendicular to the y-z plane. The first and second polarization converting elements 163 and 164 can each be a half wave-plate (HWP) or a polarization converter/rotator (PCR), and the first and second angles can each be 45°. In other embodiments, the first and second angles are not necessarily 45°. If the first and second angles are not 45°, the calculation of these two angles must be modified. In other words, the included angle between the P wave and the transmission axis is the first angle (or the second angle), and the included angle between the S wave and the transmission axis is the complementary angle of the first angle (or of the second angle), i.e. 90° minus the first angle (or the second angle). To be noted, the included angle between the x axis and the transmission axis of the first polarization element 161 or second polarization element 162 can be changed if the rotation angle of the two polarization states are changed by that the first polarization converting element 163 or second polarization converting element 164.

In this embodiment, because the optical interferometric apparatus 1a includes the first and second polarization converting elements 163 and 164, the included angle between the x axis and the transmission axis of the first polarization element 161 is 0° instead of 45° of the case in the optical interferometric apparatus 1. Besides, the included angle between the x axis and the transmission axis of the second polarization element 162 is also 0°. In other words, the included angle between each of the P wave and S wave of the third light L3 of this embodiment and the transmission axis of the first polarization element 161 is 45°, and also the included angle between each of the P wave and S wave of the fourth light L4 of this embodiment and the transmission axis of the second polarization element 162 is 45°.

In this embodiment, at least two of the polarizing beam-splitting element 12, the beam-splitting element 14, the first phase-modulation element 151, the second phase-modulation element 152, the first polarization converting element 163, the second polarization converting element 164, the first polarization element 161 and the second polarization element 162 can be made in an integrated optical circuit. In other words, the polarizing beam-splitting element 12, the beam-splitting element 14, the first phase-modulation element 151, the second phase-modulation element 152, the first polarization converting element 163, the second polarization converting element 164, the first polarization element 161 and the second polarization element 162 can be made in an integrated optical circuit by the integrated optical circuit process, for decreasing the size and cost of elements. Moreover, the size and cost of the optical interferometric apparatus 1a is also decreasing.

Other technical features of the optical interferometric apparatus 1a can be known by referring to the optical interferometric apparatus 1, and therefore they are not described here for concise purpose.

It is illustrated as below how to obtain the Sagnac phase. The Sagnac phase (φₛ) can be represented as “φₛ=φ_{cw}−φ_{ccw}”, wherein φ_{cw} is the induced phase shift of a clockwise direction (corresponding to the first light L1 in this embodiment) and φ_{ccw} is the induced phase shift of a counterclockwise direction (corresponding to the second light L2 in this embodiment).

After the first polarized signal S1 generated by the first detection element 171 and the second polarized signal S2 generated by the second detection element 172 are processed by the first and second filter elements 181 and 182 and demodulated by the demodulation computing element 19, the two signals S1 and S2 can be obtained as follows (detailed mathematical derivations thereof are omitted herein):

$$\begin{matrix}{I}_{1}^{AC} = \frac{1}{16} {A}_{0}^{2} {cos}^{2} θ ( L ) [ 1 + cos ( {φ}_{s} + ξ ( L ) + π + 2 {δ}_{1} ) ] & ( 1 ) \\ {I}_{2}^{AC} = \frac{1}{16} {A}_{0}^{2} {cos}^{2} θ ( L ) [ 1 + cos ( {φ}_{s} + ξ ( L ) + π + 2 {δ}_{2} ) ] & ( 2 )\end{matrix}$$

A₀ is the amplitude of the laser light, θ(L) is the total polarization rotation angle, ξ(L) is the change in ellipticity of the input polarized state, δ₁ is the phase modulated by the first phase-modulation element 151, and δ₂ is the phase modulated by the second phase-modulation element 152.

When δ₁=0° and δ₂=−π/2 are substituted into equations (1) and (2), the signal intensities can be respectively obtained as follows:

$$\begin{matrix}\begin{matrix}{I}_{1}^{cos , AC} = \frac{1}{16} {A}_{0}^{2} {cos}^{2} θ ( L ) [ 1 + cos ( {φ}_{s} + ξ ( L ) + π ) ] \\ = \frac{1}{16} {A}_{0}^{2} {cos}^{2} θ ( L ) [ 1 - cos ( {φ}_{s} + ξ ( L ) ) ]\end{matrix} & ( 3 ) \\ \begin{matrix}{I}_{2}^{cos , AC} = \frac{1}{16} {A}_{0}^{2} {cos}^{2} θ ( L ) [ 1 + cos ( {φ}_{s} + ξ ( L ) + π - π ) ] \\ = \frac{1}{16} {A}_{0}^{2} {cos}^{2} θ ( L ) [ 1 + cos ( {φ}_{s} + ξ ( L ) ) ]\end{matrix} & ( 4 )\end{matrix}$$

Then, subtracting the equation (3) from the equation (4) will get the result as follows:

$$\begin{matrix}{I}_{2}^{cos , AC} - {I}_{1}^{cos , AC} = \frac{1}{16} {A}_{0}^{2} {cos}^{2} θ ( L ) \{ [ 1 + cos ( {φ}_{s} + ξ ( L ) ) ] - \\ [ 1 - cos ( {φ}_{s} + ξ ( L ) ) ] \} \\ = \frac{1}{8} {A}_{0}^{2} {cos}^{2} θ ( L ) cos ( {φ}_{s} + ξ ( L ) )\end{matrix} \qquad ( 5 )$$

Adding the equation (4) to the equation (3) will get the result as follows:

$$\begin{matrix}{I}_{2}^{cos , AC} + {I}_{1}^{cos , AC} = \frac{1}{16} {A}_{0}^{2} {cos}^{2} θ ( L ) \{ [ 1 + cos ( {φ}_{s} + ξ ( L ) ) ] + \\ [ 1 - cos ( {φ}_{s} + ξ ( L ) ) ] \} \\ = \frac{1}{8} {A}_{0}^{2} {cos}^{2} θ ( L )\end{matrix} \qquad ( 6 )$$

Then, the equation (5) divided by the equation (6) will get the result as follows:

$$\frac{{I}_{2}^{cos , AC} - {I}_{1}^{cos , AC}}{{I}_{2}^{cos , AC} + {I}_{1}^{cos , AC}} = \frac{\frac{1}{8} {A}_{0}^{2} {cos}^{2} θ ( L ) cos ( {φ}_{s} + ξ ( L ) )}{\frac{1}{8} {A}_{0}^{2} {cos}^{2} θ ( L )} = cos ( {φ}_{s} + ξ ( L ) ) \qquad ( 7 )$$

Similarly, when δ₁=−π/4 and δ₂=π/4 are substituted into equations (1) and (2), the signal intensities can be respectively obtained as follows:

$$\begin{matrix}\begin{matrix}{I}_{1}^{sin , AC} = \frac{1}{16} {A}_{0}^{2} {cos}^{2} θ ( L ) [ 1 + cos ( {φ}_{s} + ξ ( L ) + π - \frac{π}{2} ) ] \\ = \frac{1}{16} {A}_{0}^{2} {cos}^{2} θ ( L ) [ 1 + cos ( {φ}_{s} + ξ ( L ) - \frac{π}{2} ) ] \\ = \frac{1}{16} {A}_{0}^{2} {cos}^{2} θ ( L ) [ 1 - sin ( {φ}_{s} + ξ ( L ) ) ]\end{matrix} & ( 8 ) \\ \begin{matrix}{I}_{2}^{sin , AC} = \frac{1}{16} {A}_{0}^{2} {cos}^{2} θ ( L ) [ 1 + cos ( {φ}_{s} + ξ ( L ) + π + \frac{π}{2} ) ] \\ = \frac{1}{16} {A}_{0}^{2} {cos}^{2} θ ( L ) [ 1 + cos ( {φ}_{s} + ξ ( L ) + \frac{3 π}{2} ) ] \\ = \frac{1}{16} {A}_{0}^{2} {cos}^{2} θ ( L ) [ 1 + sin ( {φ}_{s} + ξ ( L ) ) ]\end{matrix} & ( 9 )\end{matrix}$$

Then, subtracting the equation (8) from the equation (9) will get the result as follows:

$$\begin{matrix}{I}_{2}^{sin , AC} - {I}_{1}^{sin , AC} = \frac{1}{16} {A}_{0}^{2} {cos}^{2} θ ( L ) \{ [ 1 + sin ( {φ}_{s} + ξ ( L ) ) ] - \\ [ 1 + sin ( {φ}_{s} + ξ ( L ) ) ] \} \\ = \frac{1}{8} {A}_{0}^{2} {cos}^{2} θ ( L ) sin ( {φ}_{s} + ξ ( L ) )\end{matrix} \qquad ( 10 )$$

Adding the equation (9) to the equation (8) will get the result as follows:

$$\begin{matrix}{I}_{2}^{sin , AC} + {I}_{1}^{sin , AC} = \frac{1}{16} {A}_{0}^{2} {cos}^{2} θ ( L ) \{ [ 1 + sin ( {φ}_{s} + ξ ( L ) ) ] + \\ [ 1 - sin ( {φ}_{s} + ξ ( L ) ) ] \} \\ = \frac{1}{8} {A}_{0}^{2} {cos}^{2} θ ( L )\end{matrix} \qquad ( 11 )$$

Then, the equation (10) divided by the equation (11) will get the result as follows:

$$\frac{{I}_{2}^{sin , AC} - {I}_{1}^{sin , AC}}{{I}_{2}^{sin , AC} + {I}_{1}^{sin , AC}} = \frac{\frac{1}{8} {A}_{0}^{2} {cos}^{2} θ ( L ) cos ( {φ}_{s} + ξ ( L ) )}{\frac{1}{8} {A}_{0}^{2} {cos}^{2} θ ( L )} = sin ( {φ}_{s} + ξ ( L ) ) \qquad ( 12 )$$

In the equations (7) and (12), the term of the optical rotation cos² θ(L) will be eliminated. Finally, when the equation (12) is divided by the equation (7) and an arc tangent function (tan⁻¹) is used therein, the Sagnac phase φₛ can be obtained as follows:

$$\begin{matrix}{φ}_{s} = \frac{8 {π}^{2} {R}^{2} Δω}{λ c} \\ \tilde{=} {tan}^{- 1} ( {I}_{2}^{sin , AC} - {I}_{1}^{sin , AC} / {I}_{2}^{cos , AC} - {I}_{1}^{cos , AC} ) - ξ ( L ) ,\end{matrix} \qquad ( 13 )$$

In the equation (13), if the length of the optical fiber is a constant, ξ(L) is a constant. According to the cosine function in the equation (7) and sine function in the equation (12), the quadrant of Sagnac phase can be obtained to achieve full-dynamic range measurement. In following table, we can determine the relationship among the quadrant and the sine function of the equation (12) and the cosine function of the equation (7). For example, when the result of the sine function of the equation (12) is a negative value while the result of the cosine function of the equation (7) is also a negative value, the Sagnac phase is located in the third quadrant, and the rest can be deduced by analogy. The angular velocity can be obtained according to the calculation of the equation (13) once the Sagnac phase φₛ is known. That is, the phase information includes or implies the quadrant of Sagnac phase and angular velocity.

| | Result of the sine | Result of the sine |
|---|---|---|
| | function in (12) is | function in (12) is |
| | a negative value (−) | a positive value (+) |
| Result of the cosine | Third quadrant (III) | Second quadrant (II) |
| function in (7) is a | | |
| negative value (−) | | |
| Result of the cosine | Fourth quadrant (IV) | First quadrant (I) |
| function in (7) is a | | |
| positive value (+) | | |

In summary, in the optical interferometric apparatus according to this invention, the light emitted by the light source is split by the polarizing beam-splitting element, and then split again by the beam-splitting element after path through the optical fiber element at different ends. Then, the split lights are correspondingly processed by the first and second phase-modulation elements and the first and second polarization elements, and then correspondingly received by the first and second detection elements. Thereby, the optical interferometric apparatus has a common-path configuration so as to suppress the external disturbance and eliminate the optical rotation in single mode fiber. According to these features, this gyroscope can achieve more precise measurement. Besides, the first and second filter elements can filter out the direct current component of the signal, and the demodulation computing element can demodulate the two lights that are with different optical paths (different phases) so as to obtain Sagnac phase information. Thus, this optical interferometric apparatus can be a heterodyne interferometer. In an embodiment of the invention wherein the optical interferometric apparatus functions as a heterodyne interferometric gyroscope, a Sagnac phase can be obtained by the phase information for calculating an angular velocity. Furthermore, the optical interferometric apparatus of this invention has the advantage of full-dynamic range measurement.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical interferometric apparatus, comprising:
a light source emitting a coherent light;
a polarizing beam-splitting element splitting the light into a first light and a second light which have different polarization states;
an optical fiber element, wherein the first and second lights are incident on the optical fiber in a first optical path and a second optical path, respectively, and then combined to become a combined light after passing through the polarizing beam-splitting element again;
a beam-splitting element splitting the combined light into a third light and a fourth light;
a first phase-modulation element and a second phase-modulation element respectively disposed on the optical paths of the third and fourth lights and respectively causing phase retardations to the third and fourth lights;
a first polarization element and a second polarization element respectively disposed on the optical paths of the third and fourth lights, so that two polarization states of each of the third and fourth lights are projected on the transmission axes of the first and second polarization elements to generate a first polarized light and a second polarized light;
a first detection element and a second detection element respectively detecting the first polarized light passing through the first polarization element and the second polarized light passing through the second polarization element to generate a first polarized signal and a second polarized signal respectively; and
a demodulation computing element obtaining a phase information according to the first and second polarized signals.

2. The optical interferometric apparatus as recited in claim 1, wherein the light source includes an equi-amplitude two-frequency laser source (TFLS).

3. The optical interferometric apparatus as recited in claim 1, wherein the light passes through the polarizing beam-splitting element to generate the first light, and the light is reflected by the polarizing beam-splitting element to generate the second light.

4. The optical interferometric apparatus as recited in claim 1, wherein the first and second lights are respectively a primary wave and a secondary wave, or respectively a secondary wave and a primary wave.

5. The optical interferometric apparatus as recited in claim 1, wherein the optical fiber element includes a single-mode optical fiber or a polarization-maintaining optical fiber

6. The optical interferometric apparatus as recited in claim 1, wherein the optical fiber element includes at least a turn of optical fiber.

7. The optical interferometric apparatus as recited in claim 1, wherein the first and second optical paths are the combination of a clockwise direction and a counter clockwise direction.

8. The optical interferometric apparatus as recited in claim 1, wherein the first and second polarized lights are common-path each.

9. The optical interferometric apparatus as recited in claim 1, wherein the light-pass directions of the first and second optical paths in the optical fiber element are opposite to each other.

10. The optical interferometric apparatus as recited in claim 1, wherein at different times, the first phase-modulation element and the second phase-modulation element cause different phase retardation to the third light and the fourth light, respectively.

11. The optical interferometric apparatus as recited in claim 1, wherein the included angle between the two polarization states of the third light and the transmission axis of the first polarization element is 45°, and the included angle between the two polarization states of the fourth light and the transmission axis of the second polarization element is 45°.

12. The optical interferometric apparatus as recited in claim 1, further comprising:
a first polarization converting element disposed on the optical path of the third light and causing the polarization state of the third light to rotate for a first angle; and
a second polarization converting element disposed on the optical path of the fourth light and causing the polarization state of the fourth light to rotate for a second angle.

13. The optical interferometric apparatus as recited in claim 12, wherein the first angle and the second angle both are 45°.

14. The optical interferometric apparatus as recited in claim 12, wherein the included angle between the transmission axis of the first polarization element and x-axis is 0°, and the included angle between the transmission axis of the second polarization element and x-axis is 0°.

15. The optical interferometric apparatus as recited in claim 12, wherein at least two of the polarizing beam-splitting element, the beam-splitting element, the first and second phase-modulation elements, the first and second polarization converting elements and the first and second polarization elements are made in an integrated optical circuit.

16. The optical interferometric apparatus as recited in claim 12, wherein the first phase-modulation light having the first angle is incident on the first polarization element, and the second phase-modulation light having the second angle is incident on the second polarization element.

17. The optical interferometric apparatus as recited in claim 1, further comprising:
a first filter element electrically connected to the first detection element and receiving the first polarized signal to generate a third polarized signal; and
a second filter element electrically connected to the second detection element and receiving the second polarized signal to generate a fourth polarized signal.

18. The optical interferometric apparatus as recited in claim 17, wherein the demodulation computing element receives and demodulates the third and fourth polarized signals, and determines a Sagnac phase and the quadrant according to the third and fourth polarized signals.

19. The optical interferometric apparatus as recited in claim 1, wherein the demodulation computing element obtains an angular velocity according to the phase information.

20. The optical interferometric apparatus as recited in claim 1, which is a heterodyne interferometric gyroscope or a heterodyne interferometer.
